(19) United States
(12) Patent Application Publication
(10) Pub. No.: US 2003/0062981 A1
(43) Pub. Date: Apr. 3, 2003

(54) Magnetoresistance effect element and magnetoresistance effect type magnetic head

(76) Inventors: Masanori Hosomi, Miyagi (JP); Eiji Makino, Kanagawa (JP)

Correspondence Address: SONNENSCHEIN NATH & ROSENTHAL, P.O. BOX 061080, WACKER DRIVE STATION, CHICAGO, IL, 60606-1080, US

(21) Appl. No.: 10/169,632

(22) PCT Filed: Nov. 7, 2001
(86) PCT No.: PCT/JP01/09733

(30) Foreign Application Priority Data
Nov. 8, 2000 (JP) 2000-340637

(51) Int. Cl. H01F 5/00

(52) U.S. Cl. 336/200

(57) ABSTRACT

A CPP configuration of a GMR element includes a lamination layer structure portion 10 based upon a spin-valve configuration in which there are laminated a free layer 1 of which the magnetization is rotated in response to an external magnetic field, a fixed layer 3, an antiferromagnetic layer 4 for fixing the magnetization of this fixed layer 3 and a nonmagnetic layer 2 interposed between the free layer 1 and the fixed layer 3, a substantially lamination direction of this lamination layer structure portion 10, i.e., direction intersecting, e.g., perpendicular to, a plane direction is set to a conducting direction of a sense current and at least either the free layer 1 or the fixed layer 3 is divided by thin film layers having a film thickness of less than 1.9 nm and thereby formed as a multilayer form in which a plurality of heterogeneous interfaces are formed in the free layer or the fixed layer. Thus, the sensitivity of a giant magneto-resistive effect element can be improved by increasing a spin-dependence scattering of conduction electrons.

### TECHNICAL FIELD

The present invention relates to a magneto-resistive effect element and a magnetic head using magneto-resistive effect, and particularly relates to a magneto-resistive effect element and a magnetic head using magneto-resistive effect for use in detecting an external magnetic field by a giant magneto-resistive effect (GMR: Giant Magneto-resistive effect) based upon a so-called spin-valve configuration.

### BACKGROUND ART

In general, a magnetic sensor comprised of a magneto-resistive effect element and a magnetic head using such a magnetic sensor as a magnetic sensing component are widely used as transducers which are able to read out a magnetic field of a recorded signal from a magnetic recording medium, for example, at large linear density.

A conventional magneto-resistive effect element generally makes effective use of an anisotropic magneto-resistive effect in which a resistance of a magneto-resistive effect element changes in proportion to a square of a cosine of an angle formed between the magnetization direction of the element and the direction in which a sense current flowing through the element is conducted.

On the other hand, in recent years, magneto-resistive effect elements using a magneto-resistive effect based upon a GMR effect, in particular, a spin-valve effect in which a resistance change in an element through which a sense current is flowing is generated due to a spin-dependence of conduction electrons between magnetic layers disposed through a nonmagnetic layer and a spin-dependence scattering that occurs at the interfaces of respective layers have become popular increasingly.

The magneto-resistive effect element using the magneto-resistive effect based upon this spin-valve effect has the resistance change larger than that of the above magneto-resistive effect element using the anisotropic magneto-resistive effect and therefore can make up a highly-sensitive magnetic sensor and a highly-sensitive magnetic head.

When data is recorded on a magnetic recording medium at recording density of up to about 50 Gb/inch², a magneto-resistive effect element or a magneto-resistive effect magnetic head can record data at such recording density by a so-called CIP (Current In-Plane) configuration in which the direction in which a sense current flows is set to the direction extending along an electrical conduction layer, i.e., the lamination layer direction. However, when it is requested that data should be recorded on a magnetic recording medium at higher recording density, e.g., recording density of 100 Gb/inch², it is necessary that a track width should be reduced to a track width of approximately 0.1 μm. In this case, according to the CIP configuration, even when the latest dry process is utilized as a patterning technique in the current manufacturing process for manufacturing elements, there is a limit in forming an element which can realize such a narrow track width. Furthermore, according to the CIP configuration, since it is necessary that the resistance should be lowered, an area of a cross-section of a current path has to be increased. Therefore, there is a limit in realizing such a narrow track width.

On the other hand, in a giant magneto-resistive (GMR) element, there has been proposed a GMR element having a CPP (Current Perpendicular to Plane) configuration in which a sense current is flowing in the direction perpendicular to the film plane.

As this CPP type magneto-resistive effect element, a TMR element using a tunnel current has been examined. In recent years, spin-valve elements or multilayer film type elements have been examined (e.g., Japanese patent translation No. 11-509956, Japanese laid-open patent application No. 2000-30222, Japanese laid-open patent application No. 2000-228004 and The Abstract of the Lectures of the 24th Meeting of The society for Applied Magnetics of Japan 2000, p. 427).

Since the GMR element having the CPP configuration causes a sense current to flow in the direction perpendicular to the film plane as described above, even when this giant magneto-resistive effect element having the above configuration is applied to the conventional spin-valve film configuration of the CIP configuration in which a sense current is flowing in the direction extending along the film plane, there cannot be obtained a sufficiently high sensitivity. The reason for this is that, while the CIP configuration utilizes the resistance change caused by a spin-dependence scattering that occurs when a sense current flows mainly in the direction parallel to the electrical conduction layer of the spin-valve type film configuration and to the interface of the electrical conduction layer, when the magneto-resistive effect element has the CPP configuration, since a sense current flows in the direction perpendicular to the film plane, this effect cannot act effectively.

On the other hand, it has been reported that when the thickness of the free layer in the spin-valve configuration is increased, then the resistance change can be improved (see the above-mentioned Abstract of the Lectures of The Society for Applied Magnetics of Japan).

However, since a distance in which the conduction electrons are able to keep spin is limited, the resistance change cannot be improved sufficiently by increasing the thickness of the free layer.

Further, in order to increase the sensitivity as the magnetic head, a product of a saturated magnetization Ms of the free layer and a film thickness t, i.e., a value of Ms×t has to be decreased. Therefore, the above-mentioned method of improving the resistance change by increasing the film thickness of the free layer cannot be regarded as an essential solution at present. The inventor of the present invention has found out a spin-valve film configuration in which a spin-dependence scattering can be promoted in the CPP configuration and is intended to provide a highly-sensitive magneto-resistive effect element based upon such spin-valve film configuration. Therefore, it is another object of the present invention to provide a magnetic head using magneto-resistive effect which can be applied to an electromagnetic transducer element for use with, for example, an MRAM (Magnetic Random Access Memory), in particular, which can increase recording density in the application of a long-time moving picture processing, which can microminiaturize recording and reproducing bits, accordingly, which can read out a signal from this very small area at high sensitivity.

### DISCLOSURE OF INVENTION

A magneto-resistive effect element according to the present invention is a magneto-resistive effect element (GMR element) including a lamination layer structure portion having a spin-valve configuration in which at least a free layer in which magnetization is rotated in response to an external magnetic field, a fixed layer, an antiferromagnetic layer for fixing the magnetization of this fixed layer and a nonmagnetic layer interposed between the free layer and the fixed layer are laminated and in which a sense current flows in substantially the lamination layer direction of the lamination layer structure portion, i.e., the direction intersecting the plane direction, e.g., the direction perpendicular to the plane direction with at least any one of the free layer and the fixed layer being provided in the form of a multilayer film having a plurality of heterogeneous interfaces formed thereon obtained when the free layer or the fixed layer is divided by thin-film layers having a film thickness of less than 1.9 nm.

Further, the magneto-resistive effect element according to the present invention includes the above-mentioned lamination layer structure portion in which at least any one of the free layer and the fixed layer has dispersed thereto heterogeneous particles of which the desired particle diameter is less than 1.9 nm.

Furthermore, the magnetic head using magneto-resistive effect according to the present invention has the configuration of the magnetic head using magneto-resistive effect in which the respective magneto-resistive effect elements according to the present invention are used as the magnetic sensing portions.

As described above, according to the magneto-resistive effect element (GMR element) of the present invention or the magnetic head magneto-resistive effect based upon this GMR element, a resistance change ratio can be improved.

The reason for this will be described below. In the configuration according to the present invention, since a plurality of so-called heterogeneous interfaces are formed or a plurality of heterogeneous particles are dispersed in the free layer or the fixed layer in the spin-valve configuration as the form of the multilayer films separated by the thin film layers, the spin-dependence scattering with respect to the conduction electrons by the sense current flowing in substantially the lamination layer direction can be promoted with the result that the resistance change ratio can be improved.

In this specification, “heterogeneous” indicates a condition in which magneto-resistive effect can be improved, and an interface or particle that can improve the magneto-resistive effect is called a heterogeneous interface or heterogeneous particle.

Since the probability in which the spin-dependence scattering will occur increases with the increase of the number of the layers of the inserted thin-film layers which are used to form the above-mentioned heterogeneous interfaces, the magneto-resistive effect element according to the present invention or the magnetic head using magneto-resistive effect according to the present invention can exhibit satisfactory characteristics. However, in actual practice, because the total film thickness of the thin films to be inserted is limited and a film thickness of a thin film that can be deposited also is limited, the total number of the thin-film layers that can be inserted into the fixed layer or the free layer is approximately 10.

### BRIEF DESCRIPTION OF DRAWINGS

FIGS. 1A and 1B are diagrams showing fundamental arrangements of embodiments of magneto-resistive effect element according to the present invention. FIGS. 2A and 2B are diagrams showing fundamental arrangements of other embodiments of magneto-resistive effect elements according to the present invention. FIGS. 3A and 3B are schematic cross-sectional views of magneto-resistive effect elements according to the embodiments of the present invention. FIGS. 4A and 4B are schematic cross-sectional views of magneto-resistive effect elements according to the embodiments of the present invention. FIGS. 5A and 5B are schematic cross-sectional views of magneto-resistive effect elements according to the embodiments of the present invention. FIGS. 6A and 6B are schematic cross-sectional views of magneto-resistive effect elements according to the embodiment of the present invention. FIGS. 7A and 7B are schematic cross-sectional views of magneto-resistive effect elements according to the embodiment of the present invention. FIGS. BA and 8B are schematic cross-sectional views of magneto-resistive effect elements according to the embodiments of the present invention. FIGS. 9A and 9B are schematic cross-sectional views of magneto-resistive effect elements according to the embodiments of the present invention. FIGS. 10A and 10B are schematic cross-sectional views of magneto-resistive effect elements according to the embodiments of the present invention. FIG. 11 is a perspective view showing an outline of an example of a magneto-resistive effect element according to the present invention. FIG. 12 is a perspective view showing an outline of an example of a magneto-resistive effect element type head according to the present invention.

### BEST MODE FOR CARRYING OUT THE INVENTION

A magneto-resistive effect element (GMR element) according to the present invention is a GMR having a configuration based upon a spin-valve configuration in which the direction which intersects, e.g., which is perpendicular to the film plane direction is set to the direction in which a sense current is flowing (the form in which a sense current is flowing in the direction crossing the film plane direction will be referred to as a “CPP configuration” according to the present invention).

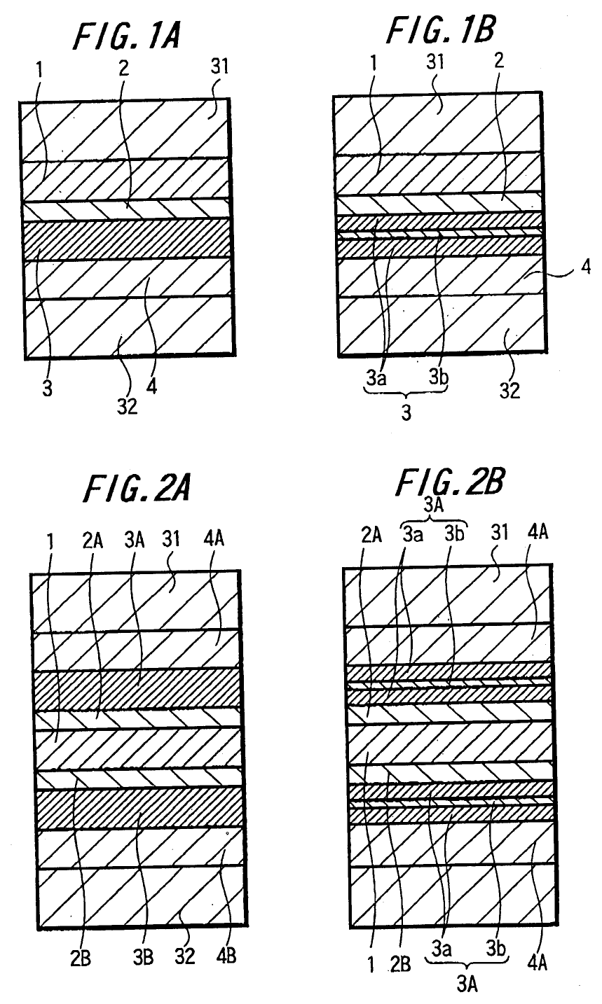

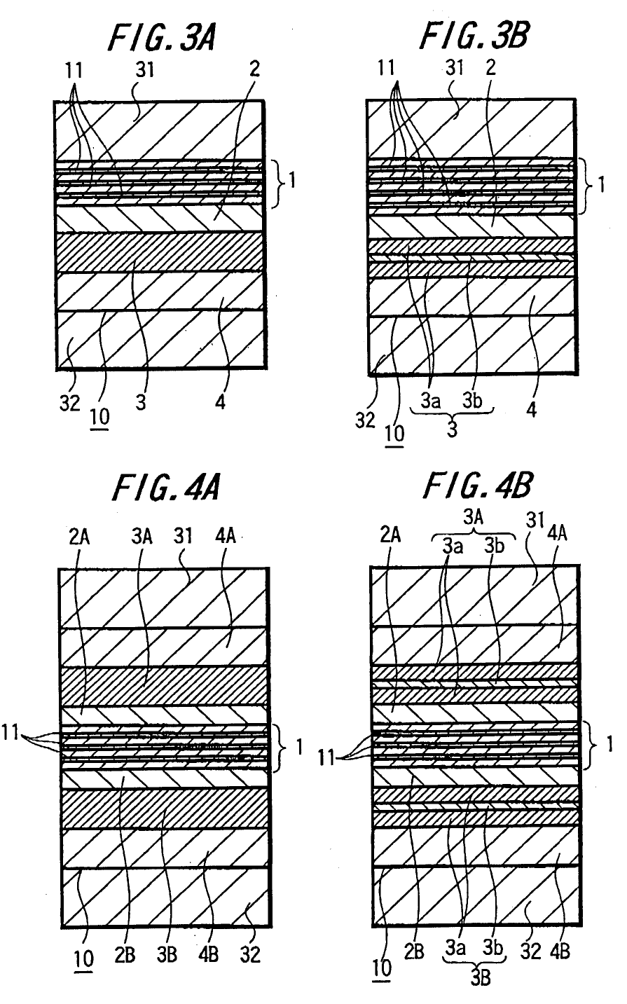

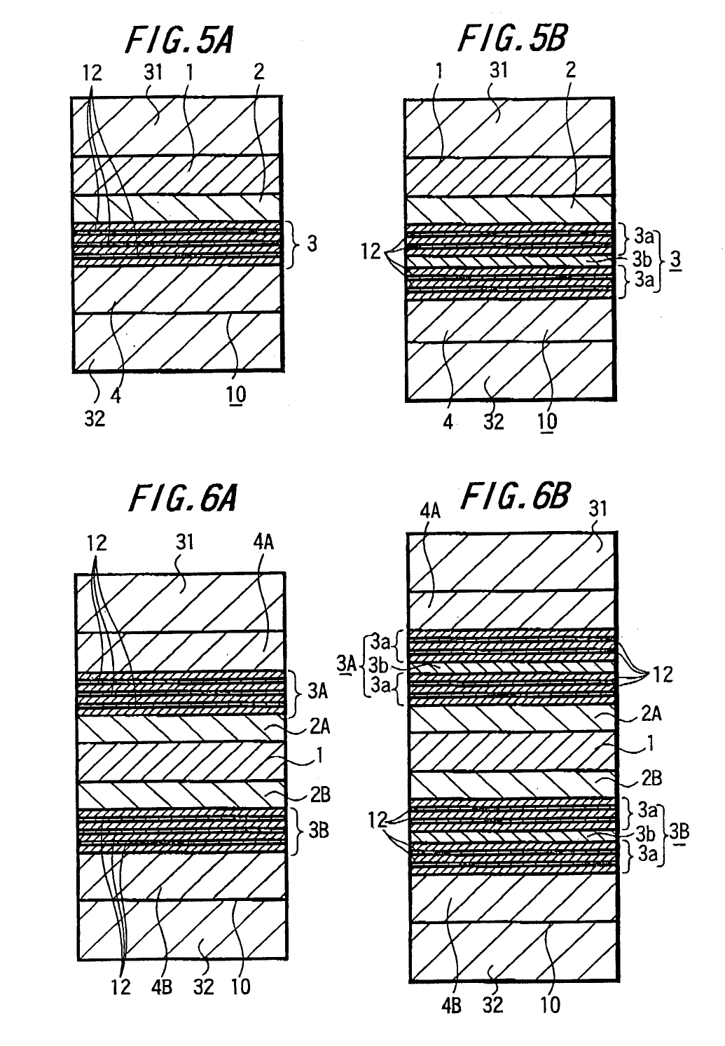

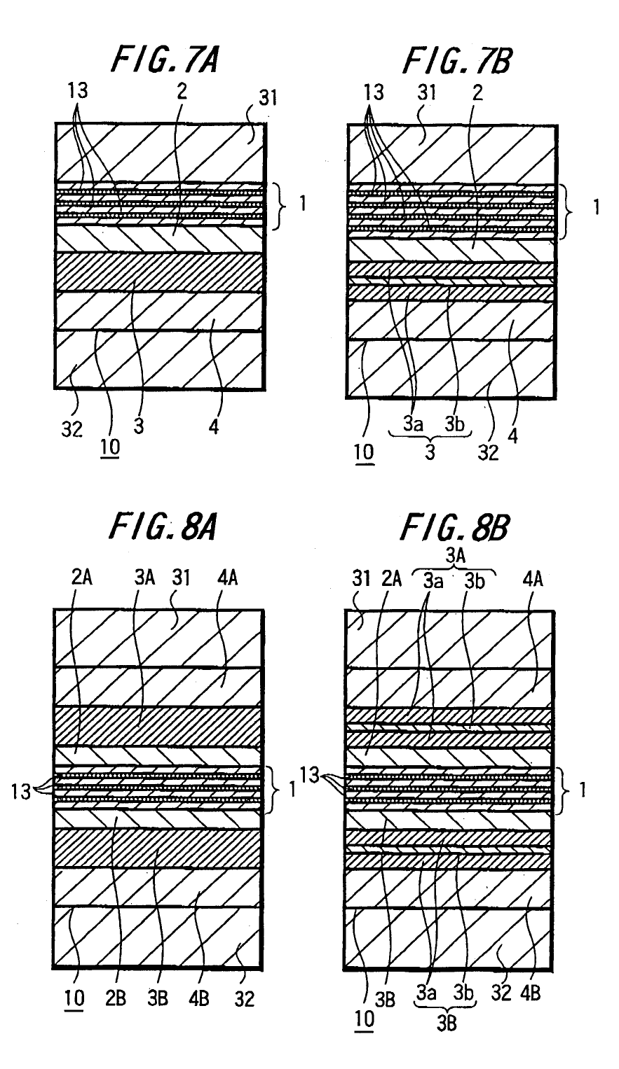

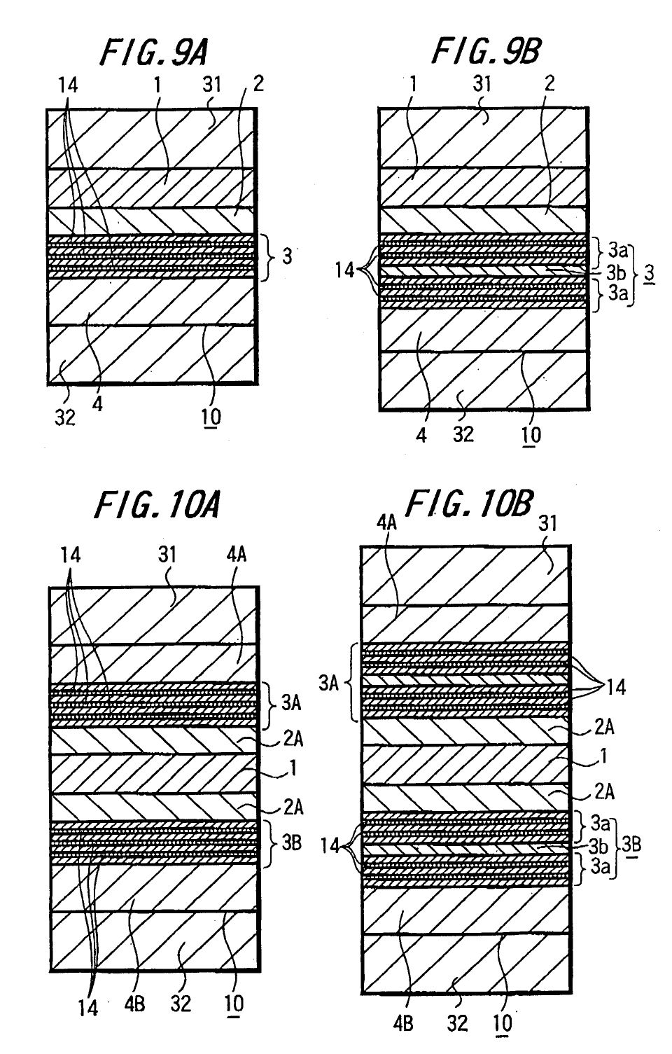

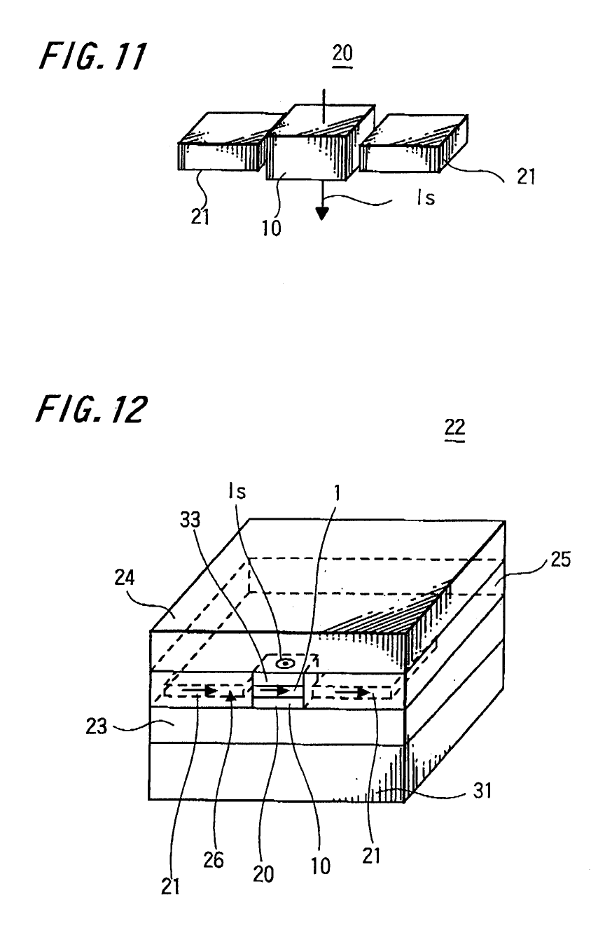

The GMR element according to the present invention can adopt spin-valve configurations of which the fundamental structures are respectively illustrated in FIGS. 1A, 1B and FIGS. 2A, 2B, for example, As FIG. 1A shows a fundamental arrangement of a magneto-resistive effect element according to the present invention, for example, the above magneto-resistive effect element can be formed as a spin-valve configuration in which a lamination layer structure comprised of a free layer 1, a nonmagnetic layer 2, a fixed layer 3 and an antiferromagnetic layer 4, each having a conductivity, is disposed between first and second electrode layers 31 and 32 which are opposed to each other. Further, as FIG. 1B shows a fundamental arrangement of another magneto-resistive effect element according to the present invention, the above-mentioned magneto-resistive effect element can be formed as a synthetic type configuration in which its fixed layer 3 is formed as a so-called lamination layer ferri-layer configuration in which a magnetic layer 3a, a nonmagnetic interposed layer 3b and the magnetic layer 3a are laminated.

In these configurations, the above-mentioned magneto-resistive effect elements can adopt the structures in which the lamination layer directions are inverted upside down.

Then, the above-mentioned magneto-resistive effect element can be formed as the CPP configuration by conducting a sense current between the first and second electrode layers.

Further, alternatively, as FIGS. 2A and 2B show the fundamental configurations of the magneto-resistive effect elements according to the present invention, respectively, in order to increase the output, the above magneto-resistive effect elements can be formed as so-called dual-spin-valve configurations in which the pair of spin-valve configurations based upon the configurations of FIGS. 1A and 1B are respectively disposed between first and second electrode layers 31 and 32. Specifically, in these magneto-resistive effect elements of the dual-spin-valve configurations, first and second nonmagnetic layers 2A and 2B, first and second fixed layers 3A and 3B and first and second antiferromagnetic layers 4A and 4B can be disposed on both sides of a free layer 1.

Also in this case, the above-mentioned magneto-resistive effect elements can be formed as the CPP configuration by conducting a sense current between the first and second electrode layers.

First Embodiment

In this embodiment, the magneto-resistive effect element can be formed as the fundamental configuration shown in FIG. 1A. As FIG. 3A shows a schematic cross-sectional view thereof, this magneto-resistive effect element includes a lamination layer structure portion 10 of which the fundamental configuration is based upon a lamination layer structure comprised of a free layer 1, a nonmagnetic layer 2, a fixed layer 3 and an antiferromagnetic layer 4. The free layer 1 is divided into a plurality of layers along the thickness direction by thin film layers 11 of more than one layer having a thickness of less than 1.9 nm and more than a monoatomic layer, whereby a plurality of heterogeneous interfaces are formed between the respective layers.

Further, in this embodiment, as FIG. 3B shows a schematic cross-sectional view thereof, for example, the above-mentioned magneto-resistive effect element can be formed as a synthetic ferri-type configuration based upon the fundamental configuration of FIG. 1B and whose fixed layer 3 is formed as a so-called lamination layer ferri-layer configuration comprised of a magnetic layer 3a and a nonmagnetic interposed layer 3b. FIG. 3B shows a configuration in which the thin-film layers 11, which are used to divide the free layer 1, are formed so as to have a four-layer structure.

In FIG. 3B, elements and parts identical to those of FIG. 3A are denoted by identical reference numerals and therefore their overlapping explanations will be avoided.

Second Embodiment

In this embodiment, the magneto-resistive effect element according to the present invention is formed as the dual-spin-valve type shown in FIG. 2A. As FIG. 4A shows a schematic cross-sectional view thereof, in the configuration in which nonmagnetic layers 2A and 2B, fixed layers 3A and 3B and antiferromagnetic layers 4A and 4B are disposed on both sides of a free layer 1, the free layer 1 is divided into a plurality of layers along the thickness direction by thin film layers 11 of more than one layer having a thickness less than 1.9 nm and more than a monoatomic layer, whereby a plurality of heterogeneous interfaces can be formed between the respective layers.

Further, in this embodiment, as FIG. 4B shows a schematic cross-sectional view thereof, this magneto-resistive effect element can be formed as a so-called synthetic ferri-type configuration based upon the fundamental configuration shown in FIG. 2B and in which the fixed layer 3 has a lamination layer ferri-layer configuration comprised of magnetic layers 3a and a nonmagnetic interposed layer 3b.

In FIG. 4B, elements and parts identical to those of FIG. 4A are denoted by identical reference numerals and therefore their overlapping explanations will be avoided.

Third Embodiment

In this embodiment, the magneto-resistive effect element according to the present invention includes the fundamental configuration shown in FIG. 1A. As FIG. 5A shows a schematic cross-sectional view thereof, this magneto-resistive effect element includes a lamination layer structure portion 10 of which the fundamental configuration is based upon a lamination layer comprised of the free layer 1, the nonmagnetic layer 2, the fixed layer 3 and the antiferromagnetic layer 4. The fixed layer 3 is divided into a plurality of layers along the thickness direction by thin film layers 12 of more than one layer having a thickness of less than 1.9 nm and more than a monoatomic layer, whereby a plurality of heterogeneous interfaces are formed between the respective layers.

Further, in this embodiment, as FIG. 5B shows a schematic cross-sectional view thereof, for example, this magneto-resistive effect element can be formed as a synthetic ferri-type configuration based upon the fundamental configuration shown in FIG. 1B and in which its fixed layer 3 has a so-called lamination layer ferri-layer configuration comprised of the magnetic layers 3a and the nonmagnetic interposed layer 3b. In this case, the magnetic layer 3a is divided into a plurality of layers along the thickness direction by the thin film layers 12 of more than one layer having a thickness of less than 1.9 nm and more than a monoatomic layer, whereby a plurality of heterogeneous interfaces are formed between the respective layers.

In FIG. 5B, elements and parts identical to those of FIG. 5A are denoted by identical reference numerals and therefore their overlapping explanations will be avoided.

Fourth Embodiment

In this embodiment, the magneto-resistive effect element according to the present invention is formed as the dual-spin-valve type shown in FIG. 2A. As FIG. 6A shows a schematic cross-sectional view thereof, in the configuration in which nonmagnetic layers 2A and 2B, fixed layers 3A and 3B and antiferromagnetic layers 4A and 4B are disposed at both sides of a fixed layer 1, its fixed layer 3 is divided into a plurality of layers along the thickness direction by thin film layers 12 of more than one layer having a thickness of less than 1.9 nm and more than a monoatomic layer, whereby a plurality of heterogeneous interfaces are formed between the respective layers.

Further, in this embodiment, as FIG. 6B shows a schematic cross-sectional view thereof, for example, this magneto-resistive effect element can be formed as a synthetic ferri-type configuration based upon the fundamental configuration of FIG. 2B and in which its fixed layer 1 is formed as a lamination layer ferri-layer configuration comprised of magnetic layers 3a and a nonmagnetic interposed layer 3b. In this case, the respective magnetic layers 3a of the two fixed layers 3A and 3B are divided into a plurality of layers along the thickness direction by thin film layers 12 of more than one layer having a thickness of less than 1.9 nm and more than a monoatomic layer, whereby a plurality of heterogeneous interfaces are formed between the respective layers.

In FIG. 6B, elements and parts identical to those of FIG. 6A are denoted by identical reference numerals and therefore their overlapping explanations will be avoided.

Fifth Embodiment

In this embodiment, the magneto-resistive effect element according to the present invention is based upon the fundamental configuration shown in FIG. 1A. As FIG. 7A shows a schematic cross-sectional view thereof, this magneto-resistive effect element includes a lamination layer structure portion 10 of which the fundamental configuration is based upon a lamination layer comprised of a free layer 1, a nonmagnetic layer 2, a fixed layer 3 and an antiferromagnetic layer 4. The free layer 1 has the configuration in which it is divided into layers of not less than one layer along the thickness direction, whereby heterogeneous particles 13 of which the particle diameter is less than 1.9 nm and more than a monoatomic particle are dispersed into these layers.

Further, in this embodiment, as FIG. 7B shows a schematic cross-sectional view thereof, for example, this magneto-resistive effect element can be formed as a synthetic ferri-type configuration based upon the fundamental configuration shown in FIG. 1B and in which its fixed layer 3 is formed as a lamination layer ferri-layer configuration comprised of magnetic layers 3a and a nonmagnetic interposed layer 3b.

In FIG. 7B, elements and parts identical to those of FIG. 7A are denoted by identical reference numerals and therefore their overlapping explanations will be avoided.

Sixth Embodiment

In this embodiment, the magneto-resistive effect element is formed as the dual-spin-valve type shown in FIG. 2A. As FIG. 8A shows a schematic cross-sectional view thereof, in a configuration in which nonmagnetic layers 2A and 2B, fixed layers 3A and 3B and antiferromagnetic layers 4A and 4B are disposed on both sides of a free layer 1, this magneto-resistive effect element is formed so as to have a configuration in which heterogeneous particles 13 whose particle diameter is less than 1.9 nm and more than a monoatomic particle are dispersed into the thickness direction of the free layer 1, in this embodiment, not less than one layer of layer-like heterogeneous particles is dispersed into the thickness direction of the free layer.

Further, in this embodiment, as FIG. 8B shows a schematic cross-sectional view thereof, for example, this magneto-resistive effect element is formed as a synthetic ferri-type configuration based upon the fundamental configuration shown in FIG. 1B and in which its fixed layer 3 is formed as a lamination layer ferri-layer configuration comprised of a magnetic layer 3a and a nonmagnetic interposed layer 3b.

In FIG. 8B, elements and parts identical to those of FIG. 8A are denoted by identical reference numerals and therefore their explanations will be avoided.

Seventh Embodiment

In this embodiment, a magneto-resistive effect element has a fundamental configuration shown in FIG. 1A. As 9A shows a schematic cross-sectional view thereof, this magneto-resistive effect element includes a lamination layer structure portion 10 the fundamental configuration of which is a lamination layer comprised of a free layer 1, nonmagnetic layer 3, a fixed layer 3 and an antiferromagnetic layer 4. This magneto-resistive effect element has a configuration in which heterogeneous particles 14 having a particle diameter less than 1.9 nm and more than a monoatommic particle layer are dispersed into the thickness direction of the fixed layer 3, in this embodiment, not less than one layer of layer-like heterogeneous particles is dispersed into the thickness direction of the fixed layer.

Further, in this embodiment, as FIG. 9B shows a schematic cross-sectional view thereof, for example, this magneto-resistive effect element can be formed as a synthetic ferri-type configuration based on the fundamental configuration shown in FIG. 1B and in which its fixed layer 3 has a lamination layer ferri-layer configuration comprised of a magnetic layer 3a and a nonmagnetic interposed layer 3b. In this case, similarly as described above, heterogeneous particles 14 whose particle diameter is less than 1.9 nm and more than a monoatomic particle diameter are dispersed into the thickness direction of the magnetic layer 3a, in this embodiment, layers more than one layer of layer-like heterogeneous particles are dispersed into the thickness direction of the magnetic layer.

In FIG. 9B, elements and parts identical to those of FIG. 9A are denoted by identical reference numerals and therefore their overlapping explanations will be avoided.

Eighth Embodiment

In this embodiment, a magneto-resistive effect element is formed as the dual-spin-valve type shown in FIG. 2A. As FIG. 10A shows a schematic cross-sectional view thereof, in a configuration in which nonmagnetic layers 2A and 2B, fixed layers 3A and 3B and antiferromagnetic layers 4A and 4B are disposed on both sides of a free layer 1, this magneto-resistive effect element has a configuration in which heterogeneous particles 14 the particle diameter of which is less than 1.9 nm and more than a monoatomic particle layer are dispersed into the thickness direction of the fixed layer 3, in this embodiment, layers more than one layer of layer-like heterogeneous particles are dispersed into the thickness direction of the fixed layer.

Further, in this embodiment, as FIG. 10B shows a schematic cross-sectional view thereof, for example, this magneto-resistive effect element is formed as a synthetic ferri-type configuration based upon the fundamental configuration shown in FIG. 2B and in which fixed layers 3A and 3B are formed as a lamination layer ferri-layer configuration comprised of a magnetic layer 3a and a nonmagnetic interposed layer 3b. In this case, this magneto-resistive effect element has a configuration in which heterogeneous particles 14 of which the particle diameter is less than 1.9 nm and more than a monoatomic particle layer are dispersed into the thickness directions of the respective magnetic layers 3a of the two fixed layers 3A and 3B, in this embodiment, not less than one layer of layer-like heterogeneous particles is dispersed into the thickness directions of the respective magnetic layers of the two fixed layers.

In FIG. 10B, elements and parts identical to those of FIG. 10A are denoted by identical reference numerals and therefore their overlapping explanations will be avoided.

Although the thin films 11 and 12 and the heterogeneous particles 13 and 14 can be made of materials comprising the corresponding free layers and fixed layers, they should preferably be made of different materials, in particular, nonmagnetic materials.

For example, the free layer 1 is generally made of a material based upon Co, CoFe alloy, Ni and NiFe alloy. Within this free layer 1, thin films of oxide or nitride can be formed into or granulated into the free layer 1 by Ti, V, Cr, Cu, Zn, Y, Zr, Nb, Mo, Tc, Ru, Rh, Pd, Ag, Hf, Ta, W, Re, Os, Ir, Pt, Au, Si, Al, Fe, Co or alloy of not less than one of these materials.

Further, with respect to the fixed layer 3, the thin films and the heterogeneous particles which comprise the heterogeneous interfaces can be made by using the above-mentioned materials.

Furthermore, it was proved that, in any one of the free layer and the fixed layer, when the free layer and the fixed layer are formed as the lamination layer ferri-structure having the multilayers by using the above-described materials, the spin-dependence scattering can be promoted so that the amount of the resistance change can be increased remarkably.

As FIG. 11 shows a schematic perspective view thereof, a GMR element according to the present invention has a configuration in which hard magnetic layers 21 magnetized to apply a bias magnetic field H_{B} to the plane direction of a lamination layer structure portion 10 so as to stabilize the free layer are disposed on both sides of the lamination layer structure portion 10 across the lamination layer structure portion and in which a sense current Is is conducted to the lamination layer direction of the lamination layer structure portion 10.

Then, the sense current Is, the bias magnetic field H_{B} and an external magnetic field of the vertical direction, i.e., a detection magnetic field H are applied to the lamination layer structure portion 10, and the resistance change caused by this external magnetic field can be obtained as an electrical output by the sense current.

As shown in FIG. 12, a magnetic head using magneto-resistive effect 22 according to the present invention has a configuration in which a lamination layer structure portion 10 and a bias hard magnetic layer 21 are disposed between, for example, a pair of magnetic field cum electrode layers 23 and 24, and in which an insulating layer 25 such as Al₂O, is filled into the magnetic shield cum electrode layers 23 and 24.

Then, in this lamination structure portion 10, i.e., GMR element 20, its free layer 1 is located at substantially the center between the magnetic shield cum electrode layers 23 and 24, and the hard magnetic layer 21 magnetized to apply the bias magnetic field to this free layer 1 is located at this central position similarly.

In a single spin-valve configuration, for example, since this free layer 1 is located lopsidedly toward any one of both surfaces of the lamination layer structure portion 10 (upper direction in the respective sheets of the drawings), on the side toward which this free layer 1 is located lopsidedly, although not shown, a nonmagnetic layer 33 having a conductivity is disposed between the lamination layer structure portion 10 and the magnetic shield cum electrode layer, e.g., magnetic shield cum electrode layer 24) so that the free layer 1 is located at nearly the center between the magnetic shield cum electrode layers 23 and 24.

Then, in this magnetic head, its magnetic sensing portion, i.e., the lamination layer structure portion 10 is disposed to come in contact with or face the opposing surface of, a magnetooptical recording medium. In a flying type magnetic head, for example, its magnetic sensing portion is faced to an ABS (Air Bearing Surface), i.e., a forward surface 26.

However, this magnetic head can be modified in such a manner that the lamination layer structure portion 10 is disposed at the position retreated from the forward surface 26 in the depth direction so that a magnetic flux introducing layer is faced to the forward surface 26 so as to introduce a magnetic field based upon recorded information from a magnetic recording medium.

While FIG. 12 shows the configuration using the magnetic shield cum electrode layers 23 and 24, the present invention is not limited thereto and can be modified into a configuration in which electrodes and magnetic shield layers are stacked up as different components.

Next, the embodiments of the GMR element will be described.

Embodiment 1

In this embodiment, the lamination layer structure portion 10 has adopted a configuration of Ta5/PtMn20/CoFe2/Ru0.9/CoFe2/Cu3/CoFe6/Ta5 (respective numerical values indicate thicknesses (nm) of respective layers, and this relationship applies for other indications as well), i.e., this lamination layer structure portion has adopted a fundamental configuration of a synthetic ferri-type single spin-valve configuration in which an antiferromagnetic layer made of PtMn having a thickness of 20 nm, a fixed layer made of CoPe having a thickness of 2 nm, Ru having a thickness of 0.9 nm and CoFe having a thickness of 2 nm, a nonmagnetic layer made of Cu having a thickness of 3 nm, a free layer made of CoFe having a thickness of 6 nm and a capping layer made of Ta having a thickness of 5 nm are laminated on an underlayer made of Ta having a thickness of 5 nm, in that order. In this configuration, the free layer made of CoFe having a thickness of 6 nm was divided by inserting a thin film made of Cu having a thickness of 1.9 nm at every thickness of 2 nm, whereby heterogeneous interfaces are formed into this free layer. Specifically, this free layer is formed so as to have a lamination layer structure comprised of CoFe2/Cu1.9/CoFe2/Cu1.9/CoFe2.

The lamination layer structure portion 10 having this configuration was annealed at 270° C. for 4 hours in the magnetic field of 10 kOe.

An electrode layer made of Cu having a thickness of 300 nm was deposited on both surfaces of this lamination layer structure portion.

Then, this lamination layer structure portion 10 was patterned into a size of 0.1 μm×0.1 μm.

Embodiment 2 to Embodiment 19

Although the lamination layer structure portions had configurations similar to that of the embodiment 1, the configurations of the free layers were changed as shown on the table 1.

Comparative Embodiment 1

Although the lamination layer structure portion had a configuration similar to that of the embodiment 1, the configuration of the free layer was comprised of only CoFe having a thickness of 6 nm.

Comparative Embodiment 2

Although the lamination layer structure portion had a configuration similar to that of the embodiment 1, the configuration of the free layer was changed as shown on the table 1.

With respect to the lamination layer structure portions of the above-mentioned embodiments 1 to 19 and those of the comparative embodiments 1 and 2, a current of 10 mA was conducted between the two electrodes and the element resistance and the resistance changes were measured. Measured results thereof are shown on the table 1.

TABLE 1

| | | | Amount of |
|---|---|---|---|
| | Inserted materials and | Element | resistance |
| | structures | resistance | change |
| | of free layers | (Ω) | (Ω) |
| Comparative | CoFe6 | 4.00 | 0.10 |
| embodiment | | | |
| 1 | | | |
| Comparative | CoFe2/Cu2.2/CoFe2/Cu2.2/CoFe2 | 5.80 | 0.30 |
| embodiment | | | |
| 2 | | | |
| Embodiment | CoFe2/Cu1.9/CoFe2/Cu1.9/CoFe2 | 5.70 | 0.50 |
| 1 | | | |
| Embodiment | CoFe2/Cu1.2/CoFe2/Cu1.2/CoFe2 | 5.50 | 0.80 |
| 2 | | | |
| Embodiment | CoFe2/Cu0.5/CoFe2/Cu0.5/CoFe2 | 4.85 | 1.60 |
| 3 | | | |
| Embodiment | CoFe1/Cu0.8/CoFe1/Cu0.8/CoFe1/ | 4.90 | 2.20 |
| 4 | Cu0.8/CoFe1/Cu0.8/CoFe1/Cu0.8/ | | |
| | CoFe1 | | |
| Embodiment | CoFe1/Cu0.5/CoFe1/Cu0.5/CoFe1/ | 4.50 | 2.80 |
| 5 | Cu0.5/CoFe1/Cu0.5/CoFe1/Cu0.5/ | | |
| | CoFe1 | | |
| Embodiment | CoFe2/Ru2.2/CoFe2/Ru2.2/CoFe2 | 7.20 | 0.20 |
| 6 | | | |
| Embodiment | CoFe2/Ru1.0/CoFe2/Ru1.0/CoFe2 | 6.85 | 1.10 |
| 7 | | | |
| Embodiment | CoFe1/Ru0.5/CoFe1/Ru0.5/CoFe1/ | 5.75 | 2.40 |
| 8 | Ru0.5/CoFe1/Ru0.5/CoFe1/Ru0.5/ | | |
| | CoFe1 | | |
| Embodiment | CoFe2/Rh0.8/CoFe2/Rh0.8/CoFe2 | 6.35 | 1.80 |
| 9 | | | |
| Embodiment | CoFe2/Pt0.7/CoFe2/Pt0.7/CoFe2 | 5.80 | 1.70 |
| 10 | | | |
| Embodiment | CoFe2/Zr0.7/CoFe2/Zr0.7/CoFe2 | 5.65 | 1.40 |
| 11 | | | |
| Embodiment | CoFe2/Ti0.7/CoFe2/Ti0.7/CoFe2 | 5.70 | 0.90 |
| 12 | | | |
| Embodiment | CoFe2/Fe0x1.0/CoFe2/Fe0x1.0/ | 6.90 | 1.25 |
| 13 | CoFe2 (1<x<2) | | |
| Embodiment | CoFe1.5/Ta1.0/CoFe1.5/Ta1.0/ | 5.80 | 1.85 |
| 14 | CoFe1.5/Ta0.1/CoFe1.5 | | |
| Embodiment | CoFe2/Y021.0/CoFe21.0/CoFe2 | 6.50 | 0.45 |
| 15 | | | |
| Embodiment | CoFe2/Si021.0/CoFe2/Si021.0/ | 6.60 | 0.95 |
| 16 | CoFe2 | | |
| Embodiment | CoFe1.5/Al0.7/CoFe1.5/Al0.7/ | 5.90 | 2.20 |
| 17 | CoFe1.5/Al0.7/CoFe1.5 | | |
| Embodiment | CoFe1.5/Au0.7/CoFe1.5/Au0.7/ | 5.40 | 1.40 |
| 18 | CoFe1.5/Au0.7/CoFe1.5 | | |
| Embodiment | CoFe1.5/Nb0.7/CoFe1.5/Nb0.7/ | 6.10 | 1.65 |
| 19 | CoFe1.5/Nb0.7/CoFe1.5 | | |

As is clear from the table 1, according to the present invention in which the heterogeneous interfaces are formed by dividing the free layer by the thin films having the thickness of less than 1.9 nm, the amount of the resistance change can be increased in excess of a target value, 0.5 Ω. Then, it was confirmed that, when the thickness of the thin films which divide the thickness of this free layer is selected to be more than that of the monoatomic layer, there can be achieved the effect in which the amount of the resistance change can be increased.

Embodiment 20

In this embodiment, the above lamination layer structure portion has adopted the synthetic ferri-type structure based upon the dual-spin-valve configuration. In this case, the above lamination layer structure portion had the configuration comprised of Ta5/PtMn20/CoFe2/Ru0.9/CoFe2/Cu3/CoFe1/NiFe6/CoFe1/Cu3/CoFe2/Ru0.9/CoFe2/PtMn20/Ta5. Specifically, the above lamination layer structure portion had the dual-spin-valve configuration of the synthetic ferri-type in which an antiferromagnetic layer made of PtMn having a thickness of 20 nm, a fixed layer of made of CoFe having a thickness of 2 nm, Ru having a thickness of 0.9 nm and CoFe having a thickness of 2 nm, a nonmagnetic layer made of Cu having a thickness of 3 nm, a free layer made of CoFe having a thickness of 1 nm, NiFe having a thickness of 6 nm and CoFe having a thickness of 1 nm, a nonmagnetic layer made of Cu having a thickness of 3 nm, a fixed layer made of CoFe having a thickness of 2 nm, Ru having a thickness of 0.9 nm and CoFe having a thickness of 2 nm, an antiferromagnetic layer made of PtMn having a thickness of 20 nm and a capping layer made of Ta having a thickness of 5 nm are laminated on a foundation layer made of Ta having a thickness of 5 nm, in that order.

Then, a lamination layer structure portion of NiFe2/Ag1.2/NiFe2/Ag1.2/NiFe2 was made by inserting thin films made of Ag having a thickness of 1.2 nm into a portion made of NiFe having a thickness of 6 nm along the thickness direction of the free layer. The resultant product was annealed at 290° C. for 4 hours in the magnetic field of 10 kOe to thereby condense Ag, i.e., sphere this material due to a surface tension. As a result, Ag granular materials were formed in the free layer.

Cu electrode layers having a thickness of 300 nm were deposited on both surfaces of this lamination layer structure portion.

Then, this lamination layer structure portion 10 was patterned into a size of 0.1 μm×0.1 μm.

Embodiment 21 to Embodiment 27

Although the lamination layer structure portions had the configurations similar to that of the embodiment 20, the configurations of the free layers were changed as shown in the table 2.

Comparative Embodiment 33

Although a lamination layer structure portion had a configuration similar to that of the embodiment 20, a free layer was made of only a CoFe layer having a thickness of 6 nm.

Comparative Embodiment 4

Although a lamination layer structure portion had a configuration similar to the embodiment 20, a configuration of a free layer was changed as shown on the table 2.

With respect to the respective lamination layer structure portions of the above-mentioned embodiments 20 to 27 and those of the above-mentioned comparative embodiments 3 and 4, the element resistance and the resistance change were measured by conducting a current of 10 mA between the two electrodes. Those measured results and the diameters of the particles produced in the respective embodiments are illustrated in the table 2.

TABLE 2

| | | | | Amount |
|---|---|---|---|---|
| | | | | of |
| | | | Element | resis- |
| | | Particle | resis- | tance |
| | Inserted materials and | diameter | tance | change |
| | structures of free layers | (nm) | (Ω) | (Ω) |
| Comparative | NiFe6 | 0 | 7.00 | 0.10 |
| embodiment | | | | |
| 3 | | | | |
| Comparative | NiFe2/Ag2.2/NiFe2/Ag2.2/ | 2.8 | 9.90 | 0.45 |
| embodiment | NiFe2 | | | |
| 4 | | | | |
| Embodiment | NiFe2/Ag1.2/NiFe2/Ag1.2/ | 1.9 | 9.15 | 3.15 |
| 20 | NiFe2 | | | |
| Embodiment | NiFe2/Ag0.5/NiFe2/Ag0.5/ | 0.7 | 9.35 | 3.80 |
| 21 | NiFe2 | | | |
| Embodiment | NiFe1/Ag0.8/NiFe1/Ag0.8/ | 1.0 | 9.50 | 4.30 |
| 22 | NiFe1/Ag0.8/NiFe1/Ag0.8/ | | | |
| | NiFe1/Ag0.8/NiFe1 | | | |
| Embodiment | NiFe1/Ag0.5/NiFe1/Ag0.5/ | 0.7 | 9.70 | 4.05 |
| 23 | NiFe1/Ag0.5/NiFe1/Ag0.5/ | | | |
| | NiFe1/Ag0.5/NiFe1 | | | |
| embodiment | NiFe2/Rh1.2/NiFe2/Rh1.3/ | 1.8 | 9.40 | 3.25 |
| 24 | NiFe2 | | | |
| Embodiment | BiFe1/Rh0.5/NiFe1/Rh0.5/ | 0.6 | 9.85 | 3.85 |
| 25 | NiFe1/Rh0.5/NiFe1/Rh0.5/ | | | |
| | NiFe1/Rh0.5/NiFe1 | | | |
| Embodiment | NiFe2/Al0.7/NiFe2/Al0.7/ | 1.0 | 9.45 | 3.35 |
| 26 | NiFe2 | | | |
| Embodiment | NiFe2/Re1.2/NiFe2/Re1.2/ | 1.8 | 9.00 | 2.75 |
| 27 | NiFe2 | | | |

As is clear from the table 2, according to the present invention in which the heterogeneous particles having a particle diameter of less than 1.9 nm were dispersed into the free layer, the resistance change can be increased in excess of a target value, 0.5 Ω. Then, the diameter of this heterogeneous particle can be made equal to the diameter of the monoatomic particle.

Embodiment 28

Also in this embodiment, the lamination layer structure portion had the synthetic ferri-type configuration based upon the dual-spin-valve configuration. In this case, this lamination layer structure portion was formed as a configuration comprised of Ta5/IrMn20/CoFe4/Ru0.9/CoFe4/Cu3/CoFe6/Cu3/CoFe4/Ru0.9/CoFe4/IrMn20/Ta5. Specifically, this lamination layer structure portion had the dual-spin-valve configuration of the synthetic ferri-type in which an antiferromagnetic layer made of IrMn having a thickness of 20 nm, a fixed layer made of CoFe having a thickness of 4 nm, Ru having a thickness of 0.9 nm and CoFe having a thickness of 4 nm, a nonmagnetic layer made of Cu having a thickness of 3 nm, a free layer made of CoFe having a thickness of 6 nm, a nonmagnetic layer made of Cu having a thickness of 3 nm, a fixed layer of CoFe having a thickness of 4 nm, Ru having a thickness of 0.9 nm and CoFe having a thickness of 4 nm, an antiferromagnetic layer made of IrMn having a thickness of 20 nm and a capping layer made of Ta having a thickness of 5 nm were laminated on an foundation layer made of Ta having a thickness of 5 nm, in that order.

Then, when the fixed layer was deposited, a fixed layer comprised of CoFe2/Cu1.9/CoFe2/Ru0.9/CoFe2/Cu1.9/CoFe2 was formed by inserting thin films made of Cu having a thickness of 1.9 nm into portions made of CoFe, each having a thickness of 4 nm.

The lamination layer structure portion thus formed was annealed at 270° C. for 4 hours in the magnetic field of 10 kOe.

A Cu electrode layer having a thickness of 300 nm was deposited on the Cu layers of both surfaces of this lamination layer structure portion.

Then, this lamination layer structure portion was patterned into a size of 0.1 μm×0.1 μm.

Embodiment 29 to Embodiment 46

Although the lamination layer structure portions had the configurations similar to that of the embodiment 28, the configurations of the fixed layers were changed as shown on the table 3.

Comparative Embodiment 5 and Comparative Embodiment 6

Although the lamination layer structure portions had the configurations similar to that of the embodiment 28, the configurations of the fixed layers were changed as shown on the table 3.

With respect to the respective lamination layer structure portions of the above-mentioned embodiments 28 to 46 and those of the above-mentioned comparative embodiments 5 and 6, the element resistance and the resistance change were measured by conducting a current of 10 mA between the two electrodes. Those measured results are shown in the table 3.

TABLE 3

| | | | Amount |
|---|---|---|---|
| | | Element | of |
| | | resis- | resis- |
| | Inserted materials and structures | tance | tance |
| | of fixed layers | (Ω) | change |
| Comparative | CeFe4/Ru0.9/CoFe4 | 6.50 | 0.10 |
| embodiment | | | |
| 5 | | | |
| Comparative | CoFe2/Cu2.2/CoFe2/Rh0.9/CoFe2/ | 8.20 | 0.01 |
| embodiment | Cu2.2/CoFe2 | | |
| 6 | | | |
| Embodiment | CoFe2/Cu1.9/CoFe2/Ru0.9/CoFe2/ | 8.00 | 0.60 |
| 28 | Cu1.9/CoFe2 | | |
| Embodiment | CoFe2/Cu1.2/CoFe2/Ru0.9/CoFe2/ | 7.70 | 1.45 |
| 29 | Cu1.2/CoFe2 | | |
| Embodiment | CoFe2/Cu0.5/CoFe2/Ru0.9/CoFe2/ | 7.25 | 3.00 |
| 30 | Cu0.5/CoFe2 | | |
| Embodiment | CoFe1/Cu0.8/CoFe1/Cu0.8/CoFe1/ | 7.85 | 3.45 |
| 31 | Cu0.8/CoFe1/Ru0.9/CoFe1/Cu0.8/ | | |
| | CoFe1/Cu0.8/CoFe1/Cu0.8/CoFe1 | | |
| Embodiment | CoFe1/Cu0.5/CoFe1/Cu0.5/CoFe1/ | 7.50 | 4.00 |
| 32 | Cu0.5/CoFe1/Ru0.9/CoFe1/Cu0.5/ | | |
| | CoFe1/Cu0.5/CoFe1/Cu0.5/CoFe1 | | |
| Embodiment | CoFe2/Ry2.2/CoFe2/Ru0.9/CoFe2/ | 8.60 | 0.01 |
| 33 | Ru2.2/CoFe2 | | |
| Embodiment | CoFe2/Ru0.6/CoFe2/Ru0.9/CoFe2/ | 7.90 | 2.85 |
| 34 | Ru0.6/CoFe2 | | |
| Embodiment | CoFe1/Ru0.5/CoFe1/Ru0.5/CoFe1/ | 8.15 | 4.10 |
| 35 | Ru0.5/CoFe1/Ru0.9/CoFe1/Ru0.5/ | | |
| | CoFe1/Ru0.5/CoFe1/Ru0.5/CoFe1 | | |
| Embodiment | CoFe2/Ru0.6/CoFe2/Ru0.9/CoFe2/ | 8.35 | 3.50 |
| 36 | Rh0.6/CoFe2 | | |
| Embodiment | CoFe2/Zr0.5/CoFe2/Ru0.9/CoFe2/ | 7.65 | 2.85 |
| 37 | Zr0.5/CoFe2 | | |
| Embodiment | CoFe1/Pt0.5/CoFe1/Pt0.5/CoFe1/ | 8.65 | 3.95 |
| 38 | Pt0.5/CoFe1/Ru0.9/CoFe1/Pt0.5/CoFe1/ | | |
| | Pt0.5/CoFe1/Pt0.5/CoFe1 | | |
| Embodiment | CoFe2/Ti0.6/CoFe2/Ru0.9/CoFe2/ | 7.65 | 2.70 |
| 39 | Ti0.6/CoFe2 | | |
| Embodiment | CoFe2/Fe0x0.5/CoFe2/Ru0.9/ | 8.80 | 3.30 |
| 40 | CoFe2Fe0x0.5/CoFe2 | | |
| Embodiment | CoFe2/Y020.5/CoFe2/Ru0.9/CoFe2/ | 8.35 | 2.80 |
| 41 | Y020.5/CoFe2 | | |
| Embodiment | CoFe1/Ta0.5/CoFe1/Ta0.5/CoFe1/ | 8.50 | 3.75 |
| 42 | Ta0.5/CoFe1/Ru0.9/CoFe1/Ta0.5/ | | |
| | CoFe1/Ta0.5/CoFe1/Ta0.5/CoFe1 | | |
| Embodiment | CoFe2/Si020.6/CoFe2/Ru0.9/CoFe2/ | 8.65 | 2.80 |
| 43 | Si020.6/CoFe2 | | |
| Embodiment | CoFe2/Al0.5/CoFe2/Ru0.9/CoFe2/ | 7.85 | 2.55 |
| 44 | Al0.5/CoFe2 | | |
| Embodiment | CoFe2.5/Au0.5/CoFe2/Ru0.9/CoFe2/ | 7.65 | 2.70 |
| 45 | Au0.5/CoFe2 | | |
| Embodiment | CoFe2.5/Nb0.5/CoFe2/Ru0.9/CoFe2/ | 8.10 | 3.05 |
| 46 | Nb0.5/CoFe2 | | |

As is clear from the table 3, according to the configurations of the present invention, the amount of the resistance change can be increased in excess of a target value, 0.5Ω. Then, it was confirmed that, when the thickness of the thin films which divide the thickness of this free layer is selected to be more than that of the monoatomic layer, there can be achieved the effect in which the amount of the resistance change can be increased.

Embodiment 47

In this embodiment, the lamination layer structure portion had the synthetic ferri-type structure based upon the single spin-valve configuration. In this case, the above-mentioned lamination layer structure portion had the configuration expressed as Ta5/PtMn20/CoFe4/Ru0.9/CoFe4/Cu3/CoFe6/Ta5. Then, while the fixed layer is being deposited, thin film layers made of Cu having a thickness of 1 nm were inserted into the portion of the CoFe4/Ru0.9/CoFe4 which is part of the fixed layer.

This lamination layer structure portion was annealed at 290° C. for 4 hours in the magnetic field of 10 kOe.

Then, electrode layers made of Cu having a thickness of 300 nm were formed on both surfaces of this lamination layer structure portion.

This lamination layer structure portion was patterned into a size of 0.1 μm×0.1 μm.

Embodiment 48 to Embodiment 51

Although the lamination layer structure portions of the above-mentioned embodiments had the configurations similar to that of the embodiment 47, the configurations of the fixed layers were changed as shown in the table 4.

Comparative Embodiment 7 and Comparative Embodiment 8

Although the lamination layer structure portions of the above-mentioned comparative embodiments had the configurations similar to that of the embodiment 47, the configurations of the fixed layers were changed as shown in the table 4.

With respect to the respective lamination layer structure portions of the above-mentioned embodiments 47 to 51 and those of the above-mentioned comparative embodiments 7 and 8, the element resistance and the resistance change were measured by conducting a current of 10 mA between the two electrodes. Those measured results are shown in the table 4.

TABLE 4

| | | | Amount of |
|---|---|---|---|
| | | Element | resis- |
| | | resis- | tance |
| | Inserted materials and | tance | change |
| | structures of fixed layers | (Ω) | (Ω) |
| Comparative | CoFe4/Ru0.9/CoFe4 | 4.50 | 0.10 |
| embodiment | | | |
| 7 | | | |
| Comparative | CoFe2/Cu2.2/CoFe2/Ru0.9/CoFe2/ | 5.90 | 0.01 |
| embodiment | Cu2.2/CoFe2 | | |
| 8 | | | |
| Embodiment | CoFe2/Cu1.0/CoFe2/Ru0.9/CoFe2/ | 6.25 | 1.65 |
| 47 | Cu1.0/CoFe2 | | |
| Embodiment | CoFe1/Cu1.0/CoFe1/Cu1.0/CoFe1/ | 6.70 | 2.45 |
| 48 | Cu1.0/CoFe1/Ru0.9/CoFe1/Cu1.0/ | | |
| | CoFe1/Cu1.0/CoFe1/Cu1.0/CoFe1 | | |
| Embodiment | CoFe2/Ru2.2/CoFe2/Ru0.9/CoFe2/ | 7.05 | 0.01 |
| 49 | Ru2.2/CoFe2 | | |
| Embodiment | CoFe2/Ru0.9/CoFe2/Ru0.9/CoFe2/ | 6.40 | 2.70 |
| 50 | Ru0.9/CoFe2 | | |
| Embodiment | CoFe1/Ru0.9/CoFe1/Ru0.9/CoFe1/ | 6.95 | 3.30 |
| 51 | Ru0.9/CoFe1/Ru0.9/CoFe1/Ru0.9/ | | |
| | CoFe1/Ru0.9/CoFe1/Ru0.9/CoFe1 | | |

As described above, it was to be understood that, even when the lamination layer ferri-layer structure is divided at the fixed layer to thereby provide the multilayer structure, similar effects can be achieved as a result.

As described above, according to the present invention, not only the MR ratio can directly be increased by the multilayer structure but also the resistance value R of the element can be increased, whereby the resistance change dR can be increased.

Specifically, although the magneto-resistive ratio (MR ratio) is increased due to the spin-dependence scattering of the conduction electrons, since this MR ratio is expressed as dR/R=MR ratio, if this MR ratio is determined, then the resistance value R of the element is increased by the existence of the thin films which divide the fixed layer or the free layer and the dispersed heterogeneous particles. As a consequence, it becomes possible to increase the resistance change amount dR.

As described above, according to the present invention, since the giant magneto-resistive effect element has the CPP configuration, the giant magneto-resistive effect element can be microminiaturized. Therefore, the magnetic head according to the present invention in which the inventive GMR element is formed as the magnetic sensing portion can reduce the track width. Thus, the magnetic head according to the present invention can increase the recording density, and it becomes possible to configure a reproducing head which can reproduce data recorded at recording density of up to 100 Gb/inch², for example,.

Further, when a magnetic induction type magnetic head, e.g., thin film recording magnetic head, for example, is laminated on the magnetic head using magneto-resistive effect according to the present invention and is thereby formed as a unitary structure, the magnetic head using magneto-resistive effect according to the present invention can be formed as a recording and reproducing magnetic head.

It is needless to say that the GMR elements according to the present invention and the magnetic heads utilizing such giant magneto-resistive effect elements are not limited to the above-mentioned embodiments and that they can be modified into various configurations.

As described above, according to the configurations of the present invention, since the free layer or the fixed layer in the spin-valve configuration are divided by the thin film layers to provide a plurality of so-called heterogeneous interfaces in the form of a multilayer or the heterogeneous particles are made to exist in the free layer or the fixed layer, the spin-dependence scattering that occurs with respect to the conduction electrons due to the sense current in the lamination layer direction in the CPP type configuration can be increased, thereby making it possible to increase the MR ratio.

Further, in this predetermined MR ratio, since the resistance value in the spin-valve configuration can be increased so that the resistance change can be improved, it is possible to increase the detection output of the external magnetic field in the spin-valve.

Therefore, in the magnetic head using magneto-resistive effect according to the present invention, it becomes possible to increase the reproduced output of the signal magnetic field based upon the recorded information from the magnetic recording medium.

Furthermore, according to the configuration of the present invention, since the magneto-resistive effect element adopts the CPP configuration, the magneto-resistive effect element can be microminiaturized. Therefore, since the magnetic head according to the present invention in which the GMR element according to the present invention comprises the magnetic sensing portion can reduce the track width, it becomes possible to reproduce data which had been recorded at a high recording density.

1. A magneto-resistive effect element being characterized by including a lamination layer structure portion in which at least a free layer whose magnetization is rotated in response to an external magnetic field, a fixed layer, an antiferromagnetic layer for fixing the magnetization of said fixed layer and a nonmagnetic layer interposed between said free layer and said fixed layer are laminated and wherein
a conducting direction of a sense current is set to substantially a lamination layer direction of said lamination layer structure portion, and
said free layer has a plurality of heterogeneous interfaces formed thereon in the form of a multilayer film by dividing said free layer into thin film layers having a film thickness of less than 1.9 nm in the film thickness direction.

2. A magneto-resistive effect element according to claim 1, being characterized by having said lamination layer structure portion that includes a lamination layer structure portion in which first and second fixed layers, first and second antiferromagnetic layers for fixing magnetizations of said first and second fixed layers and first and second nonmagnetic layers interposed between said free layer and said first and second fixed layers are laminated at both surfaces of said free layer across said free layer.

3. A magneto-resistive effect element being characterized by including a lamination layer structure portion in which at least a free layer of which the magnetization is rotated in response to an external magnetic field, a fixed layer, an antiferromagnetic layer for fixing the magnetization of said fixed layer and a nonmagnetic layer interposed between said free layer and said fixed layer are laminated with each other and
wherein a conduction direction of a sense current is set to substantially a lamination layer direction of said lamination layer structure portion and said fixed layer has a plurality of heterogeneous interfaces formed thereon in the form of a multilayer film by dividing said fixed layer into thin film layers having a film thickness of less than 1.9 nm in the film thickness direction.

4. A magneto-resistive effect element according to claim 2, being characterized by having said lamination layer structure portion that includes a lamination layer structure portion in which first and second fixed layers, first and second antiferromagnetic layers for fixing magnetizations of said first and second fixed layers and first and second nonmagnetic layers interposed between said free layer and said first and second fixed layers are laminated at both surfaces of said free layer across said free layer.

5. A magneto-resistive effect element being characterized by having a lamination layer structure portion in which at least a free layer whose magnetization is rotated in response to an external magnetic field, a fixed layer, an antiferromagnetic layer for fixing the magnetization of said fixed layer and a nonmagnetic layer interposed between said free layer and said fixed layer are laminated with each other and wherein
a conducting direction of a sense current is set to substantially a lamination layer direction of said lamination layer structure portion and said free layer has a configuration in which heterogeneous particles are dispersed into said free layer.

6. A magneto-resistive effect element according to claim 5, being characterized by having said lamination layer structure portion that includes a lamination layer structure portion in which first and second fixed layers, first and second antiferromagnetic layers for fixing magnetizations of said first and second fixed layers and first and second nonmagnetic layers interposed between said free layer and said first and second fixed layers are laminated at both surfaces of said free layer across said free layer.

7. A magneto-resistive effect element according to claim 5 or 6, being characterized in that said heterogeneous particles have a particle diameter of less than 1.9 nm.

8. A magneto-resistive effect element being characterized by having a lamination layer structure in which at least a free layer of which the magnetization is rotated in response to an external magnetic field, an antiferromagnetic layer for fixing a magnetization of said fixed layer and a nonmagnetic layer interposed between said free layer and said fixed layer are laminated with each other and wherein
a conducting direction of a sense current is set to substantially a lamination layer direction of said lamination layer structure portion and said fixed layer has a configuration in which heterogeneous particles are dispersed into said free layer.

9. A magneto-resistive effect element according to claim 5, being characterized by having said lamination layer structure portion that includes a lamination layer structure portion in which first and second fixed layers, first and second antiferromagnetic layers for fixing the magnetizations of said first and second fixed layers and first and second nonmagnetic layers interposed between said free layer and said first and second fixed layers are laminated at both surfaces of said free layer across said free layer.

10. A magneto-resistive effect element according to claim 8 or 9, being characterized in that said heterogeneous particles have a particle diameter of less than 1.9 nm.

11. A magnetic head using magneto-resistive effect being characterized by making a magneto-resistive effect element a magnetic sensing portion having a lamination layer structure portion in which at least a free layer of which the magnetization is rotated in response to an external magnetic field, a fixed layer, an antiferromagnetic layer for fixing the magnetization of said fixed layer and a nonmagnetic layer interposed between said free layer and said fixed layer are laminated and a conducting direction of a sense current is set to substantially a lamination layer direction of said lamination layer structure portion, said free layer having a plurality of heterogeneous interfaces formed thereon in the form of a multilayer film by dividing said free layer into thin film layers having a film thickness of less than 1.9 nm in the film thickness direction.

12. A magnetic head using magneto-resistive effect according to claim 11, being characterized by having said lamination layer structure portion that includes a lamination layer structure portion in which first and second fixed layers, first and second antiferromagnetic layers for fixing the magnetizations of said first and second fixed layers and first and second nonmagnetic layers interposed between said free layer and said first and second fixed layers are laminated at both surfaces of said free layer across said free layer.

13. A magnetic head using magneto-resistive effect being characterized by making a magneto-resistive effect element a magnetic sensing portion having a lamination layer structure portion in which at least a free layer of which the magnetization is rotated in response to an external magnetic field, a fixed layer, an antiferromagnetic layer for fixing the magnetization of said fixed layer and a nonmagnetic layer interposed between said free layer and said fixed layer are laminated and in which a conducting direction of a sense current is set to substantially a lamination layer direction of said lamination layer structure portion, said fixed layer having a plurality of heterogeneous interfaces formed thereon in the form of a multilayer film by dividing said fixed layer into thin film layers having a film thickness of less than 1.9 nm in the film thickness direction.

14. A magnetic head using magneto-resistive effect according to claim 12, being characterized by having said lamination layer structure portion that includes a lamination layer structure portion in which first and second fixed layers, first and second antiferromagnetic layers for fixing the magnetizations of said first and second fixed layers and first and second nonmagnetic layers interposed between said free layer and said first and second fixed layers are laminated at both surfaces of said free layer across said free layer.

15. A magnetic head using magneto-resistive effect being characterized by making a magneto-resistive effect element a magnetic sensing portion having a lamination layer structure portion in which at least a free layer of which the magnetization is rotated in response to an external magnetic field, a fixed layer, an antiferromagnetic layer for fixing the magnetization of said fixed layer and a nonmagnetic layer interposed between said free layer and said fixed layer are laminated and in which a conducting direction of a sense current is set to substantially a lamination layer direction of said lamination layer structure portion, said magnetic head using magneto-resistive, said free layer having a configuration in which heterogeneous particles are dispersed into said free layer.

16. A magnetic head using magneto-resistive effect being characterized by making a magneto-resistive effect element a magnetic sensing portion having a lamination layer structure portion in which first and second fixed layers, first and second antiferromagnetic layers for fixing the magnetizations of said first and second fixed layers and first and second nonmagnetic layers interposed between said free layer and said first and second fixed layers are laminated at both surfaces of said free layer across said free layer.

17. A magneto-resistive effect element according to claim 15 or 16, being characterized in that said heterogeneous particles have a particle diameter of less than 1.9 nm.

18. A magnetic head using magneto-resistive effect being characterized by making a magneto-resistive effect element a magnetic sensing portion having a lamination layer structure portion in which at least a free layer of which the magnetization is rotated in response to an external magnetic field, a fixed layer, an antiferromagnetic layer for fixing the magnetization of said fixed layer and a nonmagnetic layer interposed between said free layer and said fixed layer are laminated with each other and in which a conducting direction of a sense current is set to substantially a lamination layer direction of said lamination layer structure portion, said fixed layer having a configuration in which heterogeneous particles are dispersed into said free layer.

19. A magnetic head using magneto-resistive effect according to claim 15, being characterized by having said lamination layer structure portion that includes a lamination layer structure portion in which first and second fixed layers, first and second antiferromagnetic layers for fixing the magnetizations of said first and second fixed layers and first and second nonmagnetic layers interposed between said free layer and said first and second fixed layers are laminated at both surfaces of said free layer across said free layer.

20. A magneto-resistive effect element according to claim 18 or 19,being characterized in that said heterogeneous particles have a particle diameter of less than 1.9 nm.
